(19) United States
(12) Patent Application Publication
(10) Pub. No.: US 2011/0109163 A1
(43) Pub. Date: May 12, 2011

(54) 77-78-93 PATRIOT SYSTEMS

(76) Inventor: Kenneth Bennett, Louisville, KY (US)

(21) Appl. No.: 12/942,067

(22) Filed: Nov. 9, 2010

Related U.S. Application Data
(60) Provisional application No. 61/260,157, filed on Nov. 11, 2009.

(51) Int. Cl. H02J 9/00

(52) U.S. Cl. 307/66

(57) ABSTRACT

A backup energy supply system including: a self-charging system with a wiring assembly; a plurality of batteries for providing electrical storage and converting chemical energy directly to electrical energy; a plurality of inverters for converting direct current to alternating current; at least one electrical outlet; at least one on/off switch all enclosed within an aesthetic furniture item for interior storage and use. The device may be used to power electrical appliances during power outage periods.

### CROSS-REFERENCE TO RELATED APPLICATION

The present application is related to and claims priority from prior provisional application Ser. No. 61/260,157, filed Nov. 11, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of backup power systems and more specifically relates to backup power systems, which are capable of safely, quietly and effectively supplying supplemental electricity in the event of a power outage.

2. Description of the Related Art

The following includes information that may be useful in understanding the present invention(s). It is not an admission that any of the information provided herein is prior art, or material, to the presently described or claimed inventions, or that any publication or document that is specifically or implicitly referenced is prior art.

Modernly many individuals use power to perform routine daily tasks. In the event of an AC power interruption in grid power, such as during a storm, most devices in homes are rendered unusable without access to an active power supply potentially causing individuals inconvenience. Such inconveniences may include oversleeping because the alarm clock is not able to keep the proper time, getting cold due to the furnace not operating, being unable to cook or other such undesirable situations. The majority of people may be unprepared for the outage and may not have the appropriate flashlights or candles in a readily accessible location. As a result a dangerous condition may be posed by trying to get around in the dark, especially for the elderly or small children. There are many devices and electrical appliances that require electricity that people have become accustomed to using, such as microwaves, hair dryers, washing machines, and the like that are not usable during power-outage durations. Further, heating appliances and other critical potentially life-saving devices may need to be used in cases of emergency. A need exists for a reliable source of electricity that may be readily accessible for power outages.

Electric generators convert mechanical energy to electrical energy by forcing electrons in the windings to flow through the external electrical circuit. Electric generators that are portable are typically run via internal combustion engines, wind turbines, or alternately by a hand crank to provide electricity. These generators specifically those that are operated by internal combustion engines may be used to supply power during outages, however they are typically very heavy, awkward and cause air and noise pollution in confined urban areas. Hand cranking is not typically a viable option with the use of modern high-demand appliances and wind turbine powered devices may not be reasonably portable in nature.

Various attempts have been made to solve the above-mentioned problems such as those found in U.S. Pat. Nos. 5,852,332; 4,843,251; 2005/0206344; 2004/0004459; and 2003/0141839. This prior art is representative of backup power systems. None of the above inventions and patents, taken either singly or in combination, is seen to describe the invention as claimed.

Ideally, a backup power system should require minimal maintenance and be quiet in-use, yet would operate reliably and be manufactured at a modest expense. Thus, a need exists for a reliable backup power system, capable of effectively supplying supplemental electricity in the event of a power outage and to avoid the above-mentioned problems.

### BRIEF SUMMARY OF THE INVENTION

In view of the foregoing disadvantages inherent in the known powering systems art, the present invention provides a novel backup powering system. The general purpose of the present invention, which will be described subsequently in greater detail is to provide sufficient supplemental electricity in the event of a power outage.

A backup energy supply system is disclosed herein comprising: a self-charging system with a wiring assembly; a plurality of batteries comprising at least a first and a second set of batteries for providing electrical storage and converting potential chemical energy directly to kinetic electrical energy; a plurality of inverters for converting direct current to alternating current; at least one electrical outlet; at least one on/off switch; at least one timer motor; at least one negative and positive motor switch; at least one battery charger; an air ventilation means; and a rotatable openable service lid providing accessibility to the system for maintenance.

The backup energy supply system may be housed in a console; the console is aesthetically-storable within a residence preferably having the appearance of an ottoman, a cabinet, or an interior furniture item. The console is about 27 inches high, by about 42½ inches long and about 16 inches wide. The backup energy supply system of the present invention preferably operates at a sound frequency below about 20 Hz (so it is not recognizable by the human ear—quiet and does not damage hearing or create noise-annoyance to the user or other occupants/residents). The batteries comprise secondary (rechargeable) batteries containing a wet cell for holding at least one electrolytic fluid. Ideally, the batteries and the inverters switch from one side to the other via the wiring assembly to produce a constant charge, thereby creating reliability in the present invention. The self-charging system is charged by the first set of batteries while the second set of batteries are supplying power for the backup energy supply system to energize electrical outlet(s) to run at least one electrical appliance.

A kit is also disclosed herein for manufacture or sale including a plurality of batteries, a plurality of inverters, a plurality of electrical outlets housed in the console within an interior volume of the user-preferred interior furniture item, and having a set of user instructions.

A method is discussed for using the backup energy supply system comprising the steps of: connecting the backup energy supply system in an interior room; connecting at least one appliance to the backup energy supply system (via electrical outlets); operating appliance(s) in a power-out condition. The backup energy supply system operates at a frequency below about 20 Hz as mentioned above, thus providing a virtually sound-free device for providing reliable power during power outages.

The present invention holds significant improvements and serves as a backup (supplemental) power system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, 77-78-93 Patriot Systems, a backup power system constructed and operative according to the teachings of the present invention.

FIG. 1 shows a perspective view illustrating a backup power system according to an embodiment of the present invention.

FIG. 2 is a top view illustrating the backup power system according to an embodiment of the present invention of FIG. 1.

FIG. 3 is another top view illustrating the backup power system according to an embodiment of the present invention of FIGS. 1 and 2.

FIG. 4 is a flowchart illustrating electrical flow of the backup power system according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to a powering device and more particularly to a backup powering system(s) as used to improve the supplying of supplemental electricity in the event of a power outage. As discussed above, in the event of an AC power interruption, such as during a storm or other such occurrence, most appliances are left unusable due to the lack of available power. This can cause many undesirable results including sleeping in the following morning due to the alarm not being provided a working power source. Other appliances such as microwaves, hair dryers, washing machines, and more importantly furnaces, fans and other items may not be usable. Often individuals are largely unprepared for the outage and may not have the appropriate flashlights or candles readily accessible. As may be appreciated this may lead to dangerous conditions in dark or potentially cold locations. An efficient backup power system is needed which the present invention serves to provide.

The present invention comprises a stand-alone device to provide a power source and may come in a range of sizes ranging from small desktop units to large industrial units. The basic components comprise batteries, inventors and a switch. Each battery is used independently in the circuit so that while some are charging others are active and being depleted. Power is converted by AC/DC power invertors connected to each battery. Inverter size/capacity is determined according to the desired power output and application. Switching between the DC sources is accomplished by a timed switching device, allowing batteries to be passive while others are active Timing of switches and types of switches depend on the applied application(s) of the 77-78-93 Patriot.

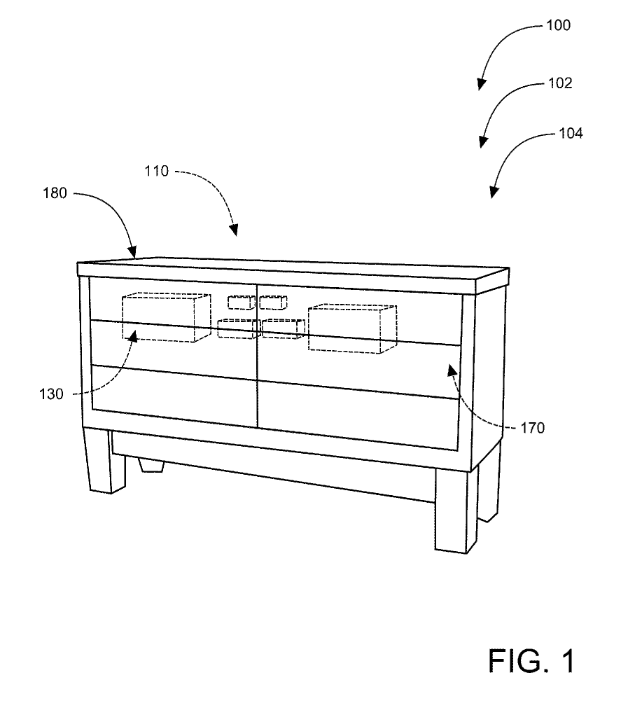

Referring now to the drawings by numerals of reference there is shown in FIG. 1, a perspective view illustrating backup power system 100 (77-78-93 Patriot Systems 110) according to an embodiment of the present invention.

A backup energy supply system 102 (backup power system 100/77-78-93 Patriot System 110) comprising: a self-charging system 104 with a wiring assembly 120; a plurality of batteries 130 comprising at least a first set 132 of batteries 130 and at least a second set 134 of batteries 130 for providing electrical storage and converting chemical energy directly to electrical energy. In this way the present invention is able to store potential energy which is readily convertible when needed to kinetic energy for use. Backup power system 100 also preferably comprises a plurality of inverters 140 for converting direct current (DC) to alternating current (AC). (AC power is required to power electrical appliances 160)

Additionally, backup power system 100 comprises at least one electrical outlet 150 (preferably a multitude of electrical outlets 150 sufficient to service of a household during a power outage). Batteries 130 within the particular embodiment shown are designed to work in conjunction with inverters 140 to switch from one side to the other via wiring assembly 120 to produce a constant charge. In this way wiring assembly 120 provides an electrical communication means between batteries 130, inverters 140 and electrical outlets 150 wherein self-charging system 104 is charged by first set 132 of batteries 130 while second set 134 of batteries 130 are supplying power for backup energy supply system 102 to energize electrical outlet 150 to run at least one electrical appliance 160. In this way the present invention serves to provide powering means for electrical appliance(s) 160 during a power outage to provide independence and safety/security for its users. In this way 77-78-93 Patriot 110 comprises backup power system 100, which is capable of effectively supplying supplemental electricity in the event of a power outage. This device has its own independent charging system (at least herein enabling self-charging system 104) and does not need constant power as provided from utility provider to power AC powered electrical appliances 160. 77-78-93 Patriot Systems 110 can be used as a stand-alone power source for in home (residential and/or business/commercial) and/or for in-field use. In this way the present invention is suitably portable and practical for many emergency and non-emergency applications.

As discussed above 77-78-93 Patriot Systems 110 comprises backup energy supply system 102, used to supply independent power. This is realized without using gas or oil, thereby creating a decreased environmental footprint due to its non-polluting emissions. This feature makes it convenient for use inside or outside residential or commercial buildings. Backup power system 100 is self-charging, which allows it to function without constant input from a grid system (utility company, power lines, etc.).

Another novel feature is that backup power system 100 is preferably contained inside a console 170 so that it can be conveniently and aesthetically placed inside the home. It may have the appearance of an ottoman, cabinet, or other piece of furniture in order to blend in with interior decorations and surroundings. Console 170 may be approximately 27″ in height, 42½″ in length, and 16″ in width in certain embodiments and may be larger or smaller or other-wised camouflaged in different ways. 77-78-93 Patriot Systems 110 preferably contains four batteries 130 and two inverters 140, which switch from one side to the other to produce a constant charge, thereby providing reliability in the event of unannounced power failures. While one set of batteries 130 is charging, the other two batteries 130 are supplying power. There are preferably two (or more) electrical outlets 150 located on the top of backup energy supply system 102 wherein electrical appliance 160, such as lights, electronics, and the like can be plugged into and thereby powered. 77-78-93 Patriot Systems 110 is able to provide power until regular grid power is restored.

77-78-93 Patriot Systems 110 may also include an on/off switch, timer motors, negative and positive motor switches, and battery chargers or combinations thereof in various embodiments. Upon reading this specification, it should be appreciated that, under appropriate circumstances, considering such issues as user preferences, design preference, structural requirements, marketing preferences, cost, available materials, technological advances, etc., other options and arrangements such as, for example, various switches, lighting mechanisms, various combinations of batteries and methods of wiring, etc., may be sufficient.

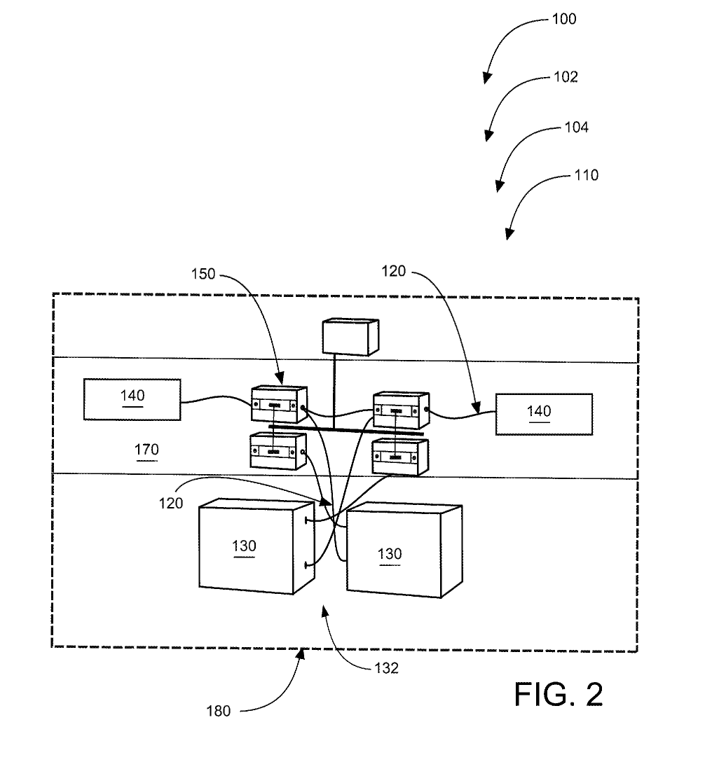

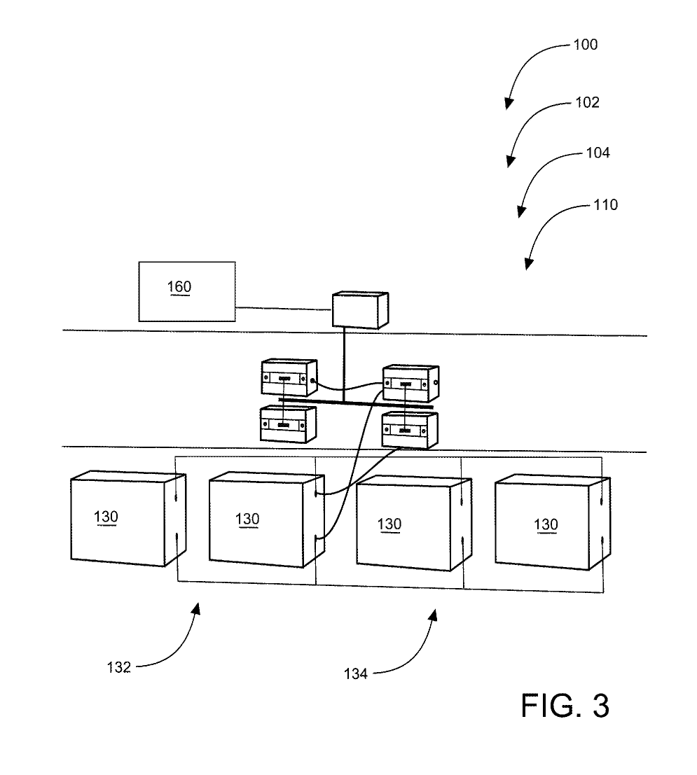

Referring now to FIGS. 2 and 3, showing top views illustrating backup power system 100 according to an embodiment of the present invention of FIG. 1.

As discussed in FIG. 1. backup energy supply system 102 is preferably housed in console 170, such that console 170 is aesthetically-storable within a residence. In certain embodiments console 170 has an external appearance of an ottoman. In other embodiments console 170 has an external appearance of a cabinet and in yet other embodiments console 170 has an external appearance of an interior furniture item 180. In this way the present invention is suitably camouflaged so that it is not noticeable when stored/used in buildings (residential and commercial). Console 170 is preferably about 27 inches high, by about 42½ inches long and about 16 inches wide for use in residential settings. Upon reading this specification, it should be appreciated that, under appropriate circumstances, considering such issues as user preferences, design preference, structural requirements, marketing preferences, cost, available materials, technological advances, etc., other console means such as, for example, dressers, desks, coffee tables, hope chests, other size dimensioning, etc., may be sufficient.

In certain embodiments of backup power system 100 interior furniture item 180 comprises an air ventilation means for providing cooling for backup power system 100, to avoid overheating and to maintain optimum efficiency in service. Further, interior furniture item 180 preferably comprises an openable service lid such that maintenance may be performed, such as on batteries 130 needing to be changed, fluid added, corrosion removed or other such related tasks.

Backup energy supply system 102 preferably comprises at least one on/off switch, as a manipulation means whereby a user may repeatedly activate or deactivate power usage. In this way the user may cause energy to flow or restrict energy from flowing to electrical appliance 160 via electrical outlet 150. This feature further serves as a safety increasing means whereby occupants are suitably protected from electrical induced injuries. Certain embodiments may further comprise at least one timer motor, wherein at least one user may time desired operations. These embodiments may additionally comprise at least one negative and positive motor switch and at least one battery charger such that additional batteries 130 or other backup power systems 100 may be charged and/or recharged.

Due to its inherent repeated charging and recharging during powered and non-powered intervals, self-charging system 104 of backup energy supply system 102 preferably comprises rechargeable (secondary versions of) batteries 130 containing at least one wet cell for holding at least one electrolytic fluid. In other versions batteries 130 may comprise dry cell(s). Those with ordinary skill in the art will now appreciate that upon reading this specification and by their understanding the art of batteries 130 as described herein, methods of powering will be understood by those knowledgeable in such art. Other versions and forms of batteries 130 may be used and still be considered to be within the scope of the present invention.

As discussed above, the preferred embodiment of backup energy supply system 102 comprises four batteries 130 and two inverters 140, which switch alternating to produce a constant charge to provide reliable and maximum charging for maximum efficiency and storage for in-use periods.

Another benefit of backup energy supply system 102 is that it may preferably operate at a frequency below 20 Hz (the lower audible hearing level of human beings), thus providing a substantially noise-free means for providing back up power and not disturbing others (especially in a urban environment where noise pollution due to population density may be an issue and/or may negatively affect individual's hearing in enclosed areas).

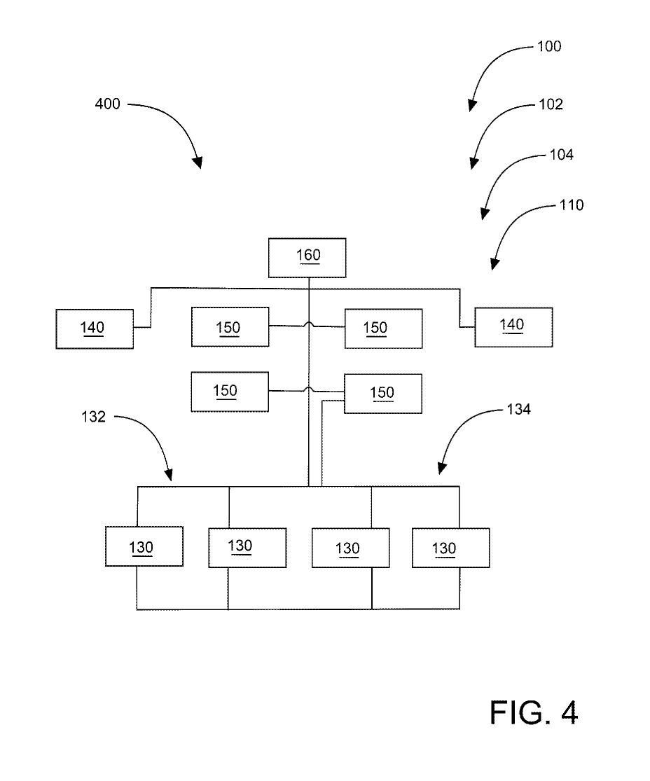

Referring now to FIG. 4, showing flowchart 400 illustrating electrical flow of backup power system 100 according to an embodiment of the present invention of FIG. 1.

Backup energy supply system 102 may comprise a kit including a plurality of batteries 130, a plurality of inverters 140 a plurality of electrical outlets 150 housed in console 170 within an interior volume of interior furniture item 180 and a set of user instructions. Backup energy supply system 102 may be sold as kit. 77-78-93 Patriot Systems 110 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different furniture combinations, parts may be sold separately, etc., may be sufficient.

A method of using backup energy supply system 100 may comprise the steps of: step one connecting backup energy supply system 102 in an interior room; step two connecting at least one electrical appliance 160 to backup energy supply system 102; step three operating at least one electrical appliance 160 in a power-out condition; and wherein backup energy supply system 102 operates at a frequency below about 20 Hz. Optionally step four may include backup energy supply system 102 being disconnected from the power grid when fully recharged. It should be noted that step four is an optional step and may not be implemented in all cases.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A backup energy supply system comprising:
a self-charging system;
a wiring assembly;
a plurality of batteries comprising at least a first and a second set of said batteries for providing electrical storage and converting chemical energy directly to electrical energy;
a plurality of inverters for converting direct current to alternating current;
at least one electrical outlet;
wherein said batteries and said inverters switch from one side to the other via said wiring assembly to produce a constant charge; and
wherein said self-charging system is charged by said first set of said batteries while said second set of said batteries are supplying power for said backup energy supply system to energize said at least one electrical outlet to run at least one electrical appliance.

2. The backup energy supply system of claim 1 wherein said backup energy supply system is housed in a console.

3. The backup energy supply system of claim 2 wherein said console is aesthetically-storable within a residence.

4. The backup energy supply system of claim 3 wherein said console has an external appearance of an ottoman.

5. The backup energy supply system of claim 3 wherein said console has an external appearance of a cabinet.

6. The backup energy supply system of claim 3 wherein said console has an external appearance of an interior furniture item.

7. The backup energy supply system of claim 3 wherein said console is about 27 inches high, by about 42½ inches long and about 16 inches wide.

8. The backup energy supply system of claim 1 further comprising at least one on/off switch.

9. The backup energy supply system of claim 1 further comprising at least one timer motor.

10. The backup energy supply system of claim 1 further comprising at least one negative and positive motor switch.

11. The backup energy supply system of claim 1 further comprising at least one battery charger.

12. The backup energy supply system of claim 1 wherein said batteries comprise rechargeable secondary batteries containing at least one wet cell for holding at least one electrolytic fluid.

13. The backup energy supply system of claim 1 wherein said batteries comprise at least one dry cell.

14. The backup energy supply system of claim 1 wherein said backup energy supply system comprises four of said batteries and two of said inverters, which switch alternating to produce a constant charge.

15. The backup energy supply system of claim 14 wherein said backup energy supply system operates at a sound frequency below about 20 Hz.

16. The backup energy supply system of claim 6 wherein said interior furniture item comprises an air ventilation means.

17. The backup energy supply system of claim 16 wherein said interior furniture item comprises an openable service lid.

18. A backup energy supply system comprising:
a self-charging system;
a wiring assembly;
a plurality of batteries comprising at least a first and a second set of said batteries for providing electrical storage and converting chemical energy directly to electrical energy;
a plurality of inverters for converting direct current to alternating current;
at least one electrical outlet;
at least one on/off switch;
at least one timer motor;
at least one negative and positive motor switch;
at least one battery charger;
air ventilation means;
a rotatable openable service lid;
wherein said backup energy supply system is housed in a console;
wherein said console is aesthetically-storable within a residence having the appearance of an ottoman, or a cabinet, or an interior furniture item;
wherein said console is about 27 inches high, by about 42½ inches long and about 16 inches wide;
wherein said backup energy supply system operates at a sound frequency below about 20 Hz;
wherein said batteries comprise rechargeable secondary batteries containing at least one wet cell for holding at least one electrolytic fluid;
wherein said batteries and said inverters switch from one side to the other via said wiring assembly to produce a constant charge; and
wherein said self-charging system is charged by said first set of said batteries while said second set of said batteries are supplying power for said backup energy supply system to energize said at least one electrical outlet to run at least one electrical appliance during at least one power outage.

19. The backup energy supply system of claim 18 wherein said backup energy supply system comprises a kit including a plurality of said batteries, a plurality of said inverters a plurality of electrical outlets housed in said console within an interior volume of said interior furniture item and a set of user instructions.

20. A method of using a backup energy supply system comprising the steps of:
connecting said backup energy supply system in an interior room;
connecting at least one appliance to said backup energy supply system via an electrical outlet;
operating said at least one appliance in a power-out condition; and
wherein said backup energy supply system operates at a sound frequency below about 20 Hz.
